(19) United States
(12) Patent Application Publication
(10) Pub. No.: US 2014/0246594 A1
(43) Pub. Date: Sep. 4, 2014

(54) GAMMA DETECTOR BASED ON GEIGERMODE AVALANCHE PHOTODIODES

(71) Applicant: Eberhard-Karls-Universitaet Tuebingen Universitaetsklinikum, Tuebingen (DE)

(72) Inventors: Bernd PICHLER, Scheyern (DE); Armin KOLB, Boerwang (DE); Eckart LORENZ, Eggstaett (DE)

(21) Appl. No.: 14/075,812

(22) Filed: Nov. 8, 2013

Related U.S. Application Data
(63) Continuation of application No. PCT/EP2012/057580, filed on Apr. 25, 2012.

(30) Foreign Application Priority Data
May 10, 2011 (EP) 11 165 555.1

(51) Int. Cl. G01T 1/202; G01T 1/20

(52) U.S. Cl. CPC G01T 1/202; G01T 1/2018
USPC 250/366; 250/369

(57) ABSTRACT

A Gamma Detector (25) comprises a scintillation crystal block (26) and a set of Geigermode Avalanche Photodiode (G-APD) sensor elements (11) optically coupled to at least a first surface (27) of the scintillation crystal block (26). The G-APD sensor elements (11) are arranged in at least one elongate strip (10) of G-APD sensor elements (11), said G-APD strip (10) coupled to a readout circuit at one, preferably at both of its ends (FIG. 2).

### BACKGROUND OF THE INVENTION

The present invention relates to a Gamma Detector comprising a scintillation crystal block and a set of Geigermode Avalanche Photodiode (G-APD) sensor elements optically coupled to at least a first surface of the scintillation crystal block.

Such Gamma Detectors are used for medical, military and security purposes. They comprise one or more scintillation crystals to convert gamma radiation into light. They further comprise one or more highly sensitive light detectors. One application for Gamma Detectors is in the field of Positron Emission Tomography (PET).

PET is a nuclear medicine imaging technique that produces a three-dimensional image of functional processes in a human or animal body. The detection is based on positrons emitted by a radionuclide, a so called tracer, which tracer is introduced into the body together with a biologically active or tolerable molecule. During decay, the tracer emits a positron which travels for a short distance until it interacts with an electron. The encounter annihilates the positron and the electron in a so-called annihilation process and produces a pair of gamma photons which are emitted in opposite direction.

The gamma photons enter a scintillation crystal where they are converted into weak light flashes which are detected by the light detector.

Conventional PET detectors are based on an array of scintillation crystals for converting the gamma rays, and on highly sensitive, low noise and fast photomultiplier tubes (PMT), which detect the scintillation light. These light detectors are bulky and relatively cost-intensive and are not suited for multimodality medical imaging devices.

As an alternative to PMTs, avalanche photodiodes (APDs) may be used, which are semiconductor-based and very compact but provide about 10³ lower electronic gain and worse timing resolution than PMTs. This impacts the PET image quality and quantification accuracy. Recently, so-called Geiger-mode APDs (G-APDs) became available which provide all the advantages of standard APDs but have a gain comparable to that of PMTs, resolve single photoelectrons, operate at much lower voltage and have an exceptional timing resolution. Also, the future costs for these GAPDs detectors will be much lower than for APDs or PMTs because of the standard CMOS production technology.

One main advantage of APDs over PMTs is their compactness, which allows a much more flexible detector design such as multilayer arrangements for higher sensitivity and depth of interaction measurements to achieve better spatial resolution.

Kolb et al., “Evaluation of Geiger-mode APDs for PET block detector design”, in Phy. Med. Biol. 55 (201) 1815-1832 present an evaluation of two types of Geiger-mode avalanche photodiodes (G-APDs) for their potential to be used in a PET detector. One G-APD sensor element used had 3600 cells per sensor element, a solid state photomultiplier (SSPM)-type G-APD sensor element used had 8100 cells per sensor element. No influences were observed while the detectors were inside a 7 T magnetic resonance (MR) scanner. A good linearity and promising time resolution of several ns (FWHM) and less was measured.

The detector comprised a 12×12 lutetium oxyorthosilicate (LSO) crystal block provided with a set of 9 G-APD sensor elements arranged in an array of 3×3 G-APD sensor elements on its upper side. Between the end face of the crystal block and the G-APD array a tapered light guide was arranged to achieve sufficient light distribution and to adapt the surface area of the crystal block to the active area of the G-APD array as for technical reasons the active area of the array was smaller than the surface area of the crystal block.

For further information on the design and advantages of G-APDs, reference is made to this paper and the prior art discussed and cited in that paper. Further, the content of this paper is incorporated into this application by reference.

In general, G-APD design uses highly granulated parallel-connected cells reducing the overall detector capacitance and operates each individual diode or cell in Geiger-mode, i.e. a few volts above breakdown voltage, in combination with a series resistor to quench the avalanche discharge triggered by a single photon, thereby preventing the APD from being destroyed. Such a semiconductor-based light detector is called Geiger-mode APD (G-APD) or silicon photomultiplier (SiPM).

Within the context of the present invention, a G-APD sensor element is a semiconductor element comprised of a large number of individual cells, each cell representing one individual diode. In the prior art, such G-APD sensor elements often are just referred to as G-APDs.

Each individual diode or cell of a G-APD sensor element can be as small as 30 μm or even below that size. Each G-APD sensor element consists of about 100-10000 cells per mm². The ideal number of cells strongly depends on the specific application; since each cell works in breakdown or Geiger-mode, they will only provide an “ON” (light detected in cell) or “OFF” (no light detected in cell) signal. This is some sort of “digital” information, it is independent of the number of photons impinging onto the cell per unit time.

Thus, the output amplitude of a G-APD just depends on the number of fired cells. The more cells per mm² a G-APD has, the higher is the dynamic range and thus the better is the linearity of the entire G-APD to resolve the amount of photons from an incident light signal that has originated from a gamma ray absorbed in a scintillation crystal which is optically coupled to the G-APD.

Overall, a rule of thumb is that a G-APD sensor element which provides a linear output signal should have at least 3 times more cells as the number of expected incident photons. In other words, the output signal is only proportional to the number of photons when the probability that each cell is hit by only one photon is considerably less than one.

To summarize, Geiger-mode APD sensor elements are very useful as the next generation of sensors for fast, low noise light detection, and will be used for Gamma Detectors where a fast time and good energy resolution is mandatory.

Besides a superior timing resolution, another major advantage of G-APDs is that they can be designed so as to be sensitive to blue light, as most common PET scintillation materials like lutetium oxyorthosilicate (LSO) or bismuth germinate (BGO) emit light around 400 nm. Blue enhanced G-APDs based on p-on-n structure are e.g. produced by Hamamatsu Photonics, Japan.

One-to-one coupling of an individual scintillation crystal with a single active area (pixel) of a light detector provides the advantage of a very good count rate performance as well as good timing and energy resolution. However, the big disadvantage of a one-to-one coupling is the required large number of readout channels. To reduce the number of electronic channels, a block detector design is usually used for commercial PET systems, to multiplex the channels at the very front end.

Another advantage of the block detector design is the usually easier assembly of the detector block compared to the handling of small single crystals.

A major problem which strikes researchers and engineers when designing a high resolution PET scanner is that they have to make a compromise between spatial resolution and sensitivity. As the crystals are arranged in an ring geometry within the PET scanner gantry, and the scintillation crystals have a certain length, the spatial resolution degrades gradually when going from the centre of the scanner's field of view (FOV) towards the edges of the FOV. This effect is known as parallax error and depends on the length of the crystals. The parallax error is especially predominant in small bore scanners like animal scanners. Thus, to get the best resolution one would need not only a very small pixel size of the scintillation crystals but also very short crystals. However, having short crystals is highly counterproductive to the sensitivity since the stopping probability for commonly used gamma quanta is increased by the crystal length.

Thus, the prior art discussed in so far still does not teach how to design a Gamma Detector that has simple overall construction, uses an as small as possible number of electronic readout channels and provides high spatial resolution and high sensitivity.

### SUMMARY OF THE INVENTION

In view of the above, it is an object of the present invention to provide a new Gamma Detector design based on G-APD sensor elements.

According to the invention, this object is achieved with the Gamma Detector mentioned at the outset in that the G-APD sensor elements are arranged in at least one elongate strip, said strip coupled to a readout circuit at one or both of its ends.

Thereby, the object underlying the invention is completely achieved.

According to the invention, only one or two readout circuits are needed for a row of several G-APD sensor elements. This reduces the number of readout circuits in the detector. If each a readout circuit is provided at each end of the detector, the signals of both readout circuits can be used to determine the strength and the location of the light within the strip. Thus, with reduced electronic effort the same information can be obtained as with a one-to-one coupling of an individual scintillation crystal with a single G-APD sensor element.

Within the scope of the present invention, the expression “elongate strip of G-APD sensor elements” refers to either an arrangement of several G-APD sensor elements lying side by side or to a monolithic strip sensor element, the G-APD strip having the width of one typical sensor element and the length of several sensor elements. The length of either the monolithic G-APD strip or of the discrete sensor elements in such G-APD strip is not less than the length of 5, preferably equal or above 10 lengths of a usual, discrete G-APD sensor element. If the G-APD strip is comprised of a row of discrete sensor elements, adjacent sensor elements are electrically connected to each other.

If the G-APD strip is a monolithic strip, it has a length of at least five or ten times the length of a usual discrete G-APD sensor element. Such monolithic G-APD strip is composed of five or ten times the number of cells or individual diodes than are present in a discrete G-APD sensor element or “pixel”.

As the width of a usual discrete G-APD sensor element equals to its length, such a monolithic strip has a length that corresponds to at least five times, preferably to at least ten times the width of the strip.

According to an improvement, two such G-APD stripes are arranged in an elongate row, with the G-APD strips having each one readout circuit at its outer end, the two inner ends of the G-APD strips being electrically connected to each other.

Here, the advantage is that with only two readout circuits the number of G-APD sensor elements is doubled and the spatial measuring range is extended.

Further, it is preferred when the set of G-APD sensor elements is arranged in an array of parallel G-APD strips, whereby preferably a second array of parallel G-APD strips is optically coupled to a second surface of the scintillation crystal block, said second surface running parallel to said first surface, and further preferably the G-APD strips in said two arrays thereof are arranged perpendicular to each other.

The array of G-APD strips allows quick and easy determination of the location of the light in the x/y plane of the first and second surface.

Further, this arrangement offers the possibility to get information on the Depth Of Interaction (DOI) which provides information where the gamma ray was absorbed within the height of the scintillation crystal block.

Via the light distribution within the crystal block on can calculate the depth of interaction by simply comparing the amount of light hitting the two arrays of G-APD strips. Although this causes an increase of costs for the detector since twice the number of G-APD strips and electronic channels are needed, this DOI scheme with a one crystal and two G-APD strip arrays configuration shows comparable performance to other approaches.

The basic elements are long strips of G-APDs to be placed on the top and bottom side of the scintillation crystal block in x and y orientation. By the so-called current division readout (z ≈Ts/(Ts+Bs), Ts, Bs being the signal charge from the top and bottom readout) one can determine the z coordinate with typically 10 to 20% of the length of the crystals to obtain rather good DOI information.

The scintillation crystal block may be a monolithic crystal block or may comprise a matrix of single scintillation crystals arranged in a matrix of rows and columns, the single crystals preferably being optically separated from each other, further preferably by interposing a reflective foil or an air gap.

The advantage associated with the use of single crystals arranged in a matrix block is that the location of the light generated by the gamma rays can be detected more precisely. For optical separation between the single crystals a reflective foil, e.g. a VM2000 (3M, USA) high reflective foil, or a small air gap can be used.

Within the first and second surface, a single crystal has a width perpendicular to the length of the G-APD strips that is equal or less than the width of the G-APD strip.

By appropriate selection of the ratio of the width of the single crystal and the G-APD strip, one can choose the desired spatial resolution perpendicular to the length of the G-APD strips.

It will be appreciated that the features mentioned above and to be explained hereinafter can be used not only in the combination indicated in each case, but also in other combinations or alone, without departing from the scope of the present invention.

### BRIEF DESCRIPTION OF THE DRAWINGS

Further advantages are evident from the following embodiments and in connection with the drawings, in which

FIG. 1 shows a schematic representation of a strip of G-APD sensor elements;

FIG. 2 shows a schematic representation of a Gamma Detector using the G-APD strips of FIG. 1; and

FIG. 3 (A) shows the energy spectra and (B) the DOI distribution calculated from strips of the cross section; (C, D) show the energy spectra and the DOI distribution calculated of all signals.

### DESCRIPTION OF PREFERRED EMBODIMENTS

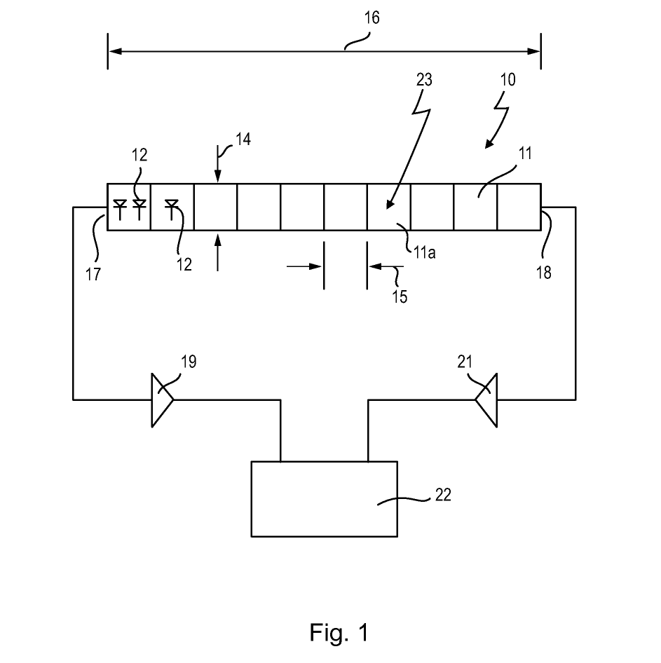

In FIG. 1 10 denotes an elongate strip of ten G-APD sensor elements 11, wherein each sensor element 11 comprises 1.000 or even more single diodes or cells 12. As an example, some cells 12 are shown in FIG. 1.

The G-APD sensor elements 11 are arranged one beside another in a row to form an elongate G-APD strip 10. Each G-APD sensor element 11 has a width indicated at 14 and a length indicated at 15. The overall length of the G-APD strip 10 as indicated at 16 thus corresponds to ten times length 15.

The G-APD sensor elements 11 form an integral strip 10 that is logically divided into ten single G-APD sensor elements 11 each of length 15. It may also be the case that ten discrete G-APD sensor elements 11 are arranged in a row to form the strip 10, whereby adjacent G-APD sensor elements 11 then are electrically connected to each other. The strip 10 may also be monolithic having a length 16 and ten times the number of cells 12 than one discrete G-APD sensor element 11.

The G-APD strip 10 has a left end 17 and a right end 18, both ends being connected to a readout circuit 19, 21. Both readout circuits are connected to a computing device 22.

A light flash 23 hitting the forth from right G-APD sensor element 11 a generates a voltage signal that will be measured by both readout circuits 17, and 18, but with different level. The level of the voltage signal depends on the number of cells 12 reacting to the light flash 23, and on the location of sensor element 11a within strip 10, i.e. on the number of G-APD sensor elements 11 lying between G-APD sensor element 11′ and the left and right end 17, 18, respectively. Due to the internal resistance of the G-APD sensor elements 11, a voltage divider is provided by the G-APD strip 10, and the value and ratio of the voltages measured by readout circuit 19 and 21, respectively, is an indication not only of the intensity of light flash 23 but also of which G-APD sensor element 11 a within the G-APD strip 10 was hit by light flash 23. Such information will be provided by computing device 22.

Thus, only two readout circuits 19, 21 are necessary to provide information on the location and the intensity of light flash 23 with a spatial resolution depending on the number of G-APD sensor elements 11 within G-APD strip 10 and/or on the measuring accuracy of readout circuits 19, 21.

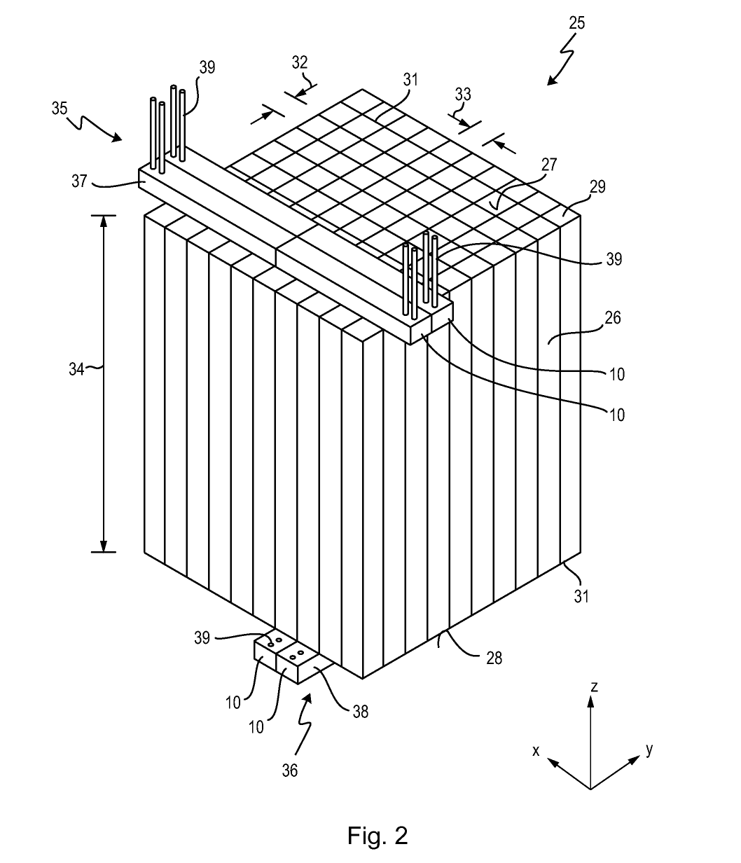

FIG. 2 shows a Gamma Detector 25 constructed with a scintillation crystal block 26 having a top surface 27 and a bottom surface 28 running parallel to upper surface 26. The block 26 is constructed as a matrix of single scintillation crystals 29 of LSO type, between adjacent single crystals 29 a gap 31 being shown that contains either air or a highly reflecting foil.

Gamma Detector 25 can be used in PET as well as in other application in need of an improved gamma ray detector.

Seen in the plane of top and bottom surfaces 27, 28, each single crystal 29 has a width 32 and a length 33. Between top and bottom surface 27, 28 each single crystal 29 has a height 34.

The block 26 is composed of 10×10 single crystals, each single crystal being of 1.5×1.5×20 mm³ (width 32×length 33×height 34) thus providing a matrix encoded readout.

The top and bottom surface 27, 28 are each optically coupled to an array 35 and 36 of G-ADP strips 10 as shown in FIG. 1. The optically coupling is done via a light guide not shown in FIG. 2 for clarity reasons. Each G-APD strip 10 is connected to one readout circuit 19, 21 as shown on FIG. 1.

Array 35 comprises ten rows 37 of strips 10, arranged in y direction parallel to each other and extending in x direction. In x direction, two strips 10 are arranged one behind the other, in order to span the length of ten single crystals 29.

Array 36 is similarly constructed, with ten rows 38 of strips 10 extending in y direction. Thus, strips 10 in array 35 run perpendicular to strips 10 in array 36. It should be noted that each array 35, 36 comprises 20 strips 10, only four strips being shown for array 35 an 36, for sake of clarity.

Strips 10 have a width 15 that corresponds to width 32 and length 33 of the single crystal 29. To increase spatial resolution within the x/y plane, width 24 can be made smaller as compared to width 32 and length 33.

The readout of the strips 10 reveals information about a light flash generated within block 25 due to a hit of a gamma ray, thereby enabling to determine the x and y location of the hit.

This readout offers a high multiplexing, a solution to detect two signals in one block (for example from Compton scattering events inside the crystals) and suppress noise in case many readout strips of one orientation are ganged together by biased amplifiers. Each single crystal 29 has assigned a unique pair of G-APD strips 10, one in array 35 the other in array 36, resulting in defined x and y information.

However, although 100 single crystals 29 can be addressed from above and from below, only as many readout circuits are required as G-APD strips are present in both arrays 35, 36.

Further, DOI information in z direction can be obtained by the so-called current division readout (z≈Ts/(Ts+Bs), Ts, Bs being the signals from a top strip 10 and bottom strip 10 for a specific single crystal 29.

In the embodiment shown, each individual G-APD strip 10 is 10 mm long and 1.4 mm wide with an active surface of 0.7×7.65 mm².

Since the total surface of an integral G-APD strip 10 is limited by current production techniques to approximately 9 mm², two strips 10 are used in each x row 37 and y column 38 to simulate a single G-ADP strip 10 which is long enough to cover an entire crystal row length. The two G-APD strips 10 in each row 37 and column 38 are electrically connected to each other at their adjoining ends and are connected to a readout circuit 19, 21 at the opposing other end via connection pins 39.

The strips are coupled either directly or with a very thin light guide to a row or column of the crystal block 26. This readout scheme is inexpensive compared to a one-to-one coupling since the number of needed readout channels is drastically reduced to only the number of rows and columns.

For the shown dimension of the 10×10 block, 20 G-APD strips on each surface 27, 28 are needed and therefore a data acquisition board with at least 40 channels. As soon as longer G-ADP strips become available, only 20 channels for each block 26 are necessary.

It is possible to extend such an readout to much larger blocks (for example up to a few 1000 single crystals 29) by summing the strips 10 of each orientation and the same x(y) coordinate. In case of an only summing a few strips 10 one can add them directly while for the reduction of the parallel capacitance load (needed for fast rise times), one can use simple summing amplifiers. The limit in adding strips 10 is normally set by noise, but biased preamplifiers open the possibility to suppress most of the noise with minimal degradation of the energy resolution.

Compared to the normal block readout this configuration has several advantages. One can observe the full signal in one strip 10, one obtains basically for free a DOI information of about 10-20% of height 34, ambiguities are resolved when 2 or even 3 signals are occurring in the same time in the same block 26, very large blocks 26 can be read out with only few readout circuits.

The inventors performed a first study to build a Geigermode Avalanche Photodiode (G-APD) based PET block detector with a high multiplexing factor and depth of interaction information (DOI) encoding. Common detectors with a high multiplexing factor are based on the principle of light sharing and are encoded with Anger logic. The Highest Multiplexing achieved in the literature was with an algorithm named T/L/E that has a one sided readout and utilizes three electronic channels. The inventive approach is based on high-energy germanium detectors with cross-strip encoding. This approach reduces the readout channels typified by light-sharing detectors, but is coupled like a normal one-to-one readout configuration. Hence, the multiplexing of the electronic readout channels compensates the loss of sensitivity by inter crystal scatter. Moreover, the detector provides DOI information and higher count rates are achievable compared to light sharing configurations, which are hindered by the prolonged recovery time of G-APDs.

Prototype G-APD strip arrays were produced (S10943-9552(X); Hamamatsu, Japan) with a 2×12 strip configuration based on 25μm cells. Each strip has a dimension 9.4 mm×1.4 mm with a gap of 0.2 mm. The maximum difference in operating voltages as indicated by the manufacturer is 0.31 V. Individual strips have been evaluated at a stable temperature of 21° C. by finding the local minima in the dU/dI*1/I vs. voltage plot. This provided the best operating voltage and range to handle signal to noise deviations induced by different break down voltages and temperature drifts. This was done by applying different operating voltages from 0 V to 78 V which were incrementally applied by steps of 0.05 V using a Keithley 2400 power supply with a GPIB remote at 8 s per step.

The 24 strips were individually amplified with a HAWK-2 amplifier compensating for the high capacitance of each strip and summed with an OPA 2695 into 12 longitudinal strips.

A stacked LSO block with a inter crystal size of 1.5 mm×1.5 mm×20mm having an etched surface with polished crystal faces and covered with an EGFR reflector was used. The G-APD arrays were placed onto opposite sides of the crystal block and coupled with optical grease (BC630; St. Gobain, France).

As shown in FIG. 2, the strips 10 were placed in a perpendicular orientation on opposite sides of the crystal block 26, whereby two individual detectors of the summed 2×12 strip were coupled to opposite sides of individual crystals 29. The crystal block 26 was irradiated with a Cs-137 source placed at a distance 10 cm away from the front face 27 of the block 26.

In this proof-of-principle evaluation only 4 channels of each array were acquired with a 4×4 crystal block. Data were acquired using an 8-channel digitizer with 250 MS/s (V1720, CAEN Nuclear Electronics, Italy). A hardware trigger from the digitizer was used for self-triggering of all 8 channels, acquiring 140 data points of which the first 10 data points were averaged for baseline subtraction of the acquired signals. Energy for each channel was calculated by summing all data points. Individual crystals were identified by calculating the maximum energy deposited on each detector located on each side of each crystal. The DOI was calculated as the fraction of total energy absorbed by both detectors onto only one of these detectors: D1/(D1+D2).

Data were analyzed following two approaches, either individual detector on each side of each crystal were summed together or those corresponding detectors were used for the crystal identification but energies were calculated using the summed signal of each array. Data of the detector were acquired over 10⁶ interactions with a trigger rate of 12 kHz.

A dI/dU*1/I plot showed the operating range of a single strip from the breakdown (71.1 V) to the upper operation limit where a strip exceeds a current above 100 μA at 77.0 V. The working operation voltage was found in the local minima to be 74.5 V with a range of ±1 V.

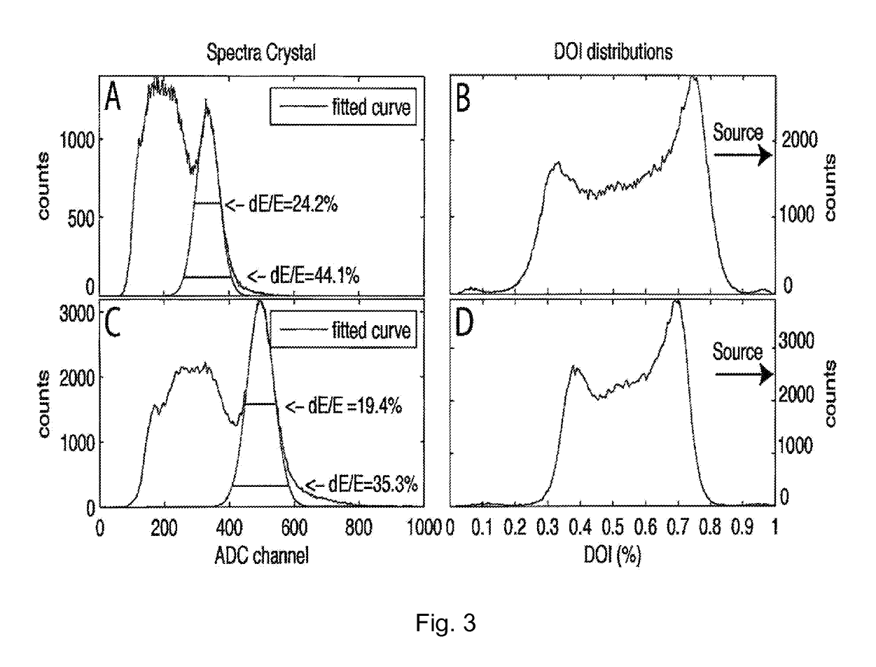

All crystals could be calculated according to corresponding detectors and the resulting energy resolution with additional DOI information. FIG. 3(A) shows the energy spectra with an energy resolution of 24.2% and (B) the DOI distribution with interactions from 15% to 90% of a crystal length which was calculated only with the maximum energy of each strip array. Energy resolution over the 4×4 array was 23.8%±1.8%.

Using the signals of the entire array, the energy resolution of the photo-peak improved to 19.4% (FIG. 3 C) and the interactions occurred from 25% to 80% of the crystal length. The energy resolution over all 16 crystals was 21.5%±2.4%.

Calculating a crystal map in order to simulate a resistive network, all crystals could be resolved.

The strips produced by Hamamatsu having a cell size of 25 μm show a wide range of operation which will show less effects in temperature drifts within ±2° C. The energy resolution in both configurations show similar results to those found in block detectors with light sharing approaches.

Since inter crystal scatter will decrease the sensitivity of a detector in a direct coupling configuration (e.g. taking only the mutual information from individual detectors coupled to opposite sides of each crystal) compared to the same data taking all signals showed a increased photo peak in energy spectra by an average factor of 2.54 over all 4×4 crystals. The calculated position profile shows blurred positions of the crystals which is also seen by the energy spectra of the outer crystals which is due to an imperfect positioning of the crystal block. The measurements show that the cross strip approach with small crystals and direct coupling could be used in future PET detectors and even panel detectors where single strips can be summed together in order to build a big strip array which would include additional DOI information.

1-13. (canceled)

14. A Gamma Detector comprising a scintillation crystal block having at least a first surface, a set of Geigermode Avalanche Photodiode (G-APD) sensor elements optically coupled to said first surface of the scintillation crystal block, and a first readout circuit,
the G-APD sensor elements being arranged in at least one elongate strip of G-APD sensor elements, said elongate strip having a first and a second end, and
said G-APD strip being coupled to said first readout circuit at its first end.

15. The Gamma Detector of claim 14, wherein a second readout circuit is provided and said G-APD strip is coupled to said second readout circuit at its second end.

16. The Gamma Detector of claim 14, said at least one G-APD strip comprising an arrangement of G-APD sensor elements lying side by side in a row of sensor elements, adjacent sensor elements being electrically connected to each other.

17. The Gamma Detector of claim 15, said at least one G-APD strip comprising an arrangement of G-APD sensor elements lying side by side in a row of sensor elements, adjacent sensor elements being electrically connected to each other.

18. The Gamma Detector of claim 16, said adjacent sensor elements being integral with each other.

19. The Gamma Detector of claim 17, said adjacent sensor elements being integral with each other.

20. The Gamma Detector of claim 18, said at least one G-APD strip being a monolithic strip having a length and a width, said width corresponding to at least five times, preferably to at least ten times said width.

21. The Gamma Detector of claim 19, said at least one G-APD strip being a monolithic strip having a length and a width, said width corresponding to at least five times, preferably to at least ten times said width.

22. The Gamma Detector of claim 16, said at least one G-APD strip including at least five G-APD sensor elements.

23. The Gamma Detector of claim 17, said at least one G-APD strip including at least five G-APD sensor elements.

24. The Gamma Detector of claim 14, two G-APD stripes being arranged in an elongate row with their second ends facing each other, each of the two G-APD strips having connected a first readout circuit at its first end, the second ends of the G-APD strips being electrically connected to each other.

25. The Gamma Detector of claim 14, wherein the set of G-APD sensor elements is arranged in an array of parallel G-APD strips.

26. The Gamma Detector of claim 25, the scintillation crystal block having a second surface running parallel to said first surface, wherein a second array of parallel G-APD strips is optically coupled to said second surface.

27. The Gamma Detector of claim 26, the G-APD strips in said two arrays thereof being arranged perpendicular to each other.

28. The Gamma Detector of claim 14, wherein the scintillation crystal block is a monolithic crystal block.

29. The Gamma Detector of claim 14, wherein the scintillation crystal block comprises a matrix of single scintillation crystals arranged in a matrix of rows and columns.

30. The Gamma Detector of claim 29, wherein the single crystals are optically separated from each other, preferably by interposing a reflective foil or an air gap.

31. The Gamma Detector of claim 29, within the first and second surface a single crystal having a width perpendicular to a length of the G-APD strips that is equal or less than a width of the G-APD strip.

32. The Gamma Detector of claim 30, within the first and second surface a single crystal having a width perpendicular to a length of the G-APD strips that is equal or less than a width of the G-APD strip.

33. A Gamma Detector comprising a scintillation crystal block having a first surface and a second surface running parallel to said first surface, a set of Geigermode Avalanche Photodiode (G-APD) sensor elements, and first readout circuits,
the set of G-APD sensor elements being arranged in a first and second array of parallel elongate strips of G-APD sensor elements, each said elongate strip having a first and a second end, and each said G-APD strip being coupled to a first readout circuit at its first end,
said first array of G-APD sensor elements being optically coupled to said first surface, and
said second array of parallel G-APD strips being optically coupled to said second surface,
the G-APD strips in said first and second arrays thereof being arranged perpendicular to each other.

34. The Gamma Detector of claim 33, wherein second readout circuits are provided and each said G-APD strip is coupled to a second readout circuit at its second end.

35. The Gamma Detector of claim 33, each two G-APD stripes in an array thereof being arranged in an elongate row with their second ends facing each other, each of the two G-APD strips having connected a first readout circuit at its first end, the second ends of the G-APD strips being electrically connected to each other.
